(19) United States
(12) Patent Application Publication
(10) Pub. No.: US 2011/0319796 A1
(43) Pub. Date: Dec. 29, 2011

(54) DUAL THERAPY EXERCISE DEVICE WITH TETHERED CONTROL PANEL

(75) Inventor: Juan José Campderá Lozano, Barcelona (ES)

(73) Assignee: Actervis GmbH, Baar/Zug (CH)

(21) Appl. No.: 13/168,343

(22) Filed: Jun. 24, 2011

Related U.S. Application Data
(60) Provisional application No. 61/358,521, filed on Jun. 25, 2010.

(51) Int. Cl. A61H 1/00

(52) U.S. Cl. 601/15; 601/46

(57) ABSTRACT

A device having a number of exercise therapy systems contained within a single housing is capable of providing multiple exercise therapies to a predetermined position of a user's body and thus efficiently exercising those portions of the user's body. To provide additional convenience, the device includes a user control panel that is movably coupled to the housing, thereby allowing removal in a manner which allow for easy user access. The multiple therapies can include both a vibration therapy and an electrical stimulation therapy, thus providing for more efficient exercising of the user's muscle tissue adjacent the housing.

### RELATED APPLICATIONS

This application is related to and claims the benefit of previously filed U.S. Provisional Application 61/358,521, filed Jun. 25, 2010 and entitled “Dual Therapy Exercise Device with Tethered Control Panel”.

### BACKGROUND

The present invention relates to a device designed to assist a user in exercising certain muscles within their body, and thus helping to manage/control the user's weight. A preferred embodiment of the invention includes a system to provide multiple exercise therapies to a user, while also having a convenient and accessible user control device.

Many different exercise and weight loss devices currently exist. In addition to typical gym equipment (i.e. weights, treadmills, exercise bikes, etc.), examples include devices which apply electrical signals to produce involuntary contractions of targeted muscles and devices which subject muscles (and other body tissue) to a physical vibration signal. To focus the desired therapy on particular portion of the user's body, each of these devices include some type of attachment system which allows the device to be appropriately positioned.

When an exercise device includes electrical systems or components, it is often necessary to appropriately position a user interface or control panel so it is easily viewed or accessed by the user. Obviously, the positioning of this user interface should be at a location which is convenient and easy to use. Unfortunately, this may be difficult when the particular exercise device is positioned at certain locations. For example, if an exercise device is positioned adjacent a user's back, it is obviously difficult to include a convenient user interface on the device itself.

In addition to the placement of the user interface, the type of therapy provided and the effectiveness of the device can vary greatly. The effectiveness of the provided therapy is critically important and is a primary consideration for the design of exercise devices. Obviously, the device should be capable of effectively providing the desired therapy, and thus producing the desired results for the user. In this case, the device must provide appropriate therapies to exercise the user's muscle tissue.

### SUMMARY

The preferred embodiments of the present invention provide a convenient multi-therapy exercise device that is capable of providing targeted exercise therapies to desired locations of a user's body. The device of the preferred embodiment provides both vibration and electrical stimulation therapy to the user by appropriately positioning the device adjacent the desired area. The dual therapies more efficiently exercise those portions of the user's body using both exercise methodologies. In addition, convenience is provided by having a control panel for the device which is detachable. In this manner, a user can easily view and access the control panel, no matter where the device is positioned.

### DESCRIPTION OF THE DRAWINGS

Further objects and advantages of the present invention are described in the following detailed description, in conjunction with the drawings, in which:

FIG. 1 is a perspective view of a first embodiment of the present invention;

FIG. 2 is a perspective view of the first embodiment with a control panel being retracted;

FIG. 3 is an inside rear view of the first embodiment; and

FIG. 4 is a schematic diagram of the interior components within the first embodiment.

### DESCRIPTION OF THE PREFERRED EMBODIMENTS

Generally speaking, the preferred embodiment includes a belt structure which is wearable by a user to allow for the application of multiple exercise therapies. In this embodiment, these therapies include vibration therapy, and electrical signal stimulation therapy. In addition, a convenient and removable control panel is provided which can facilitate operation of the exercise device while positioned at all possible locations. Further, structures are included within a housing of the exercise device to retain the control panel at a seated location so the control panel is contained and not swinging dangerously during use. To accommodate the above discussed features of the control panel, a cord take-up mechanism helps to appropriately contain the cord, which is attached between the exercise device housing and the control panel. This take-up mechanism allows the cord and attached control panel to be easily pulled away from the exercise device so the user can easily see and operate the device.

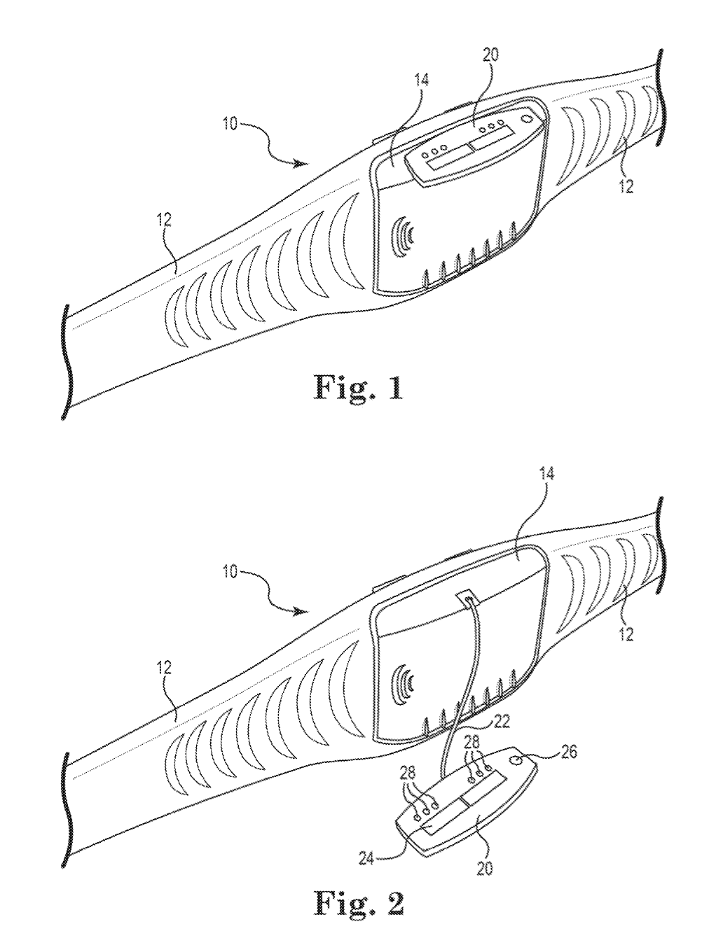

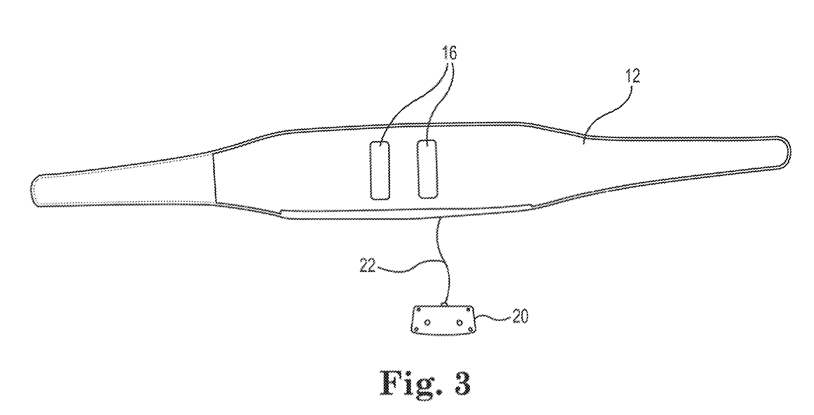

Referring now to FIGS. 1 and 2, one embodiment of an exercise device 10 of the present invention is illustrated. As shown, exercise device 10 includes a belt structure 12 and an exercise device housing 14 coupled to one another. Belt structure 12 is specifically configured to be positioned around the user's torso. That said, it is contemplated that exercise device 10 could be attached to other portions of the user's body, including arms or legs. In these alternative locations, it is also contemplated that belt structure 12 would be configured differently.

As better illustrated in FIG. 3, belt 12 also includes a pair of electrodes 16 positioned on a backside thereof. As further discussed below, electrodes 16 are configured to contact a user's body when the belt structure 12 is attached, thus providing electrical signals to stimulate muscle contractions as desired.

As also shown in FIGS. 1-3, exercise device 10 includes a removable control panel 20, which is coupled to housing 14 via a cable or cord 22. As best illustrated in FIG. 2, control panel 20 includes a display 24, a power button 26 and a plurality of control buttons 28. Each of these components are utilized to control operation of the exercise device 10 as desired by the user. As discussed below, exercise device 10 includes the systems to provide multiple exercise therapies. It is contemplated that control panel 20 would provide appropriate components (i.e. displays 24 and control buttons 28) to control the various therapy systems, either independently or in conjunction with one another.

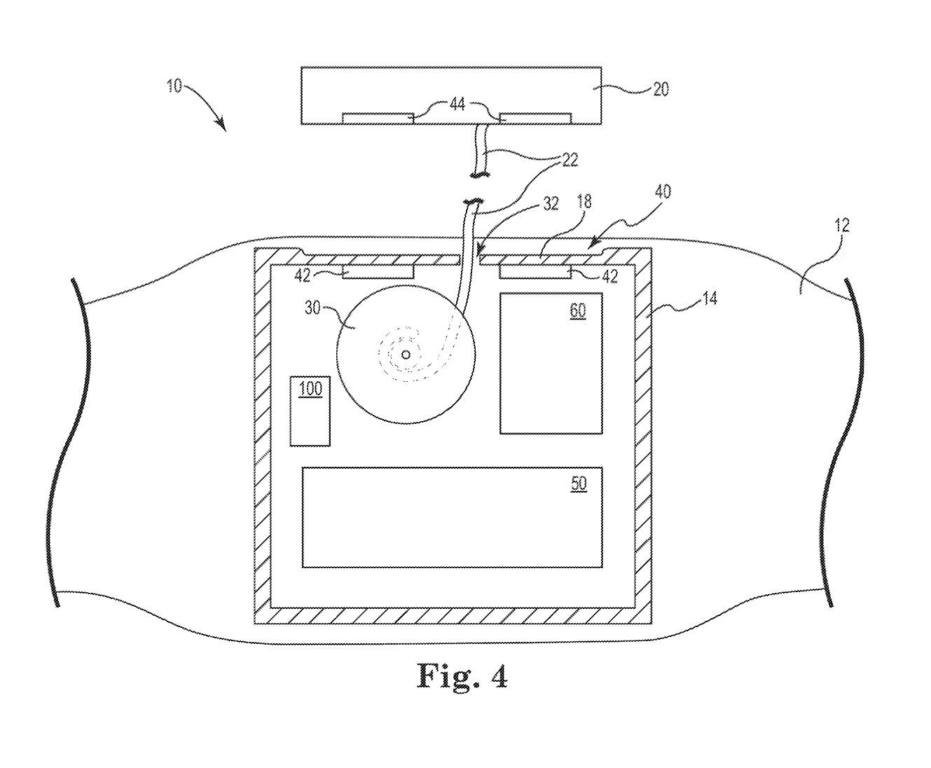

Referring now to FIG. 4, the various components of exercise device 10 are schematically illustrated. More specifically, FIG. 4 illustrates an internal schematic view of housing 14. As indicated above, cord 22 is utilized to electrically couple control panel 20 to the various components of exercise device 10. To accommodate this, and also provide convenience to the user, a take-up system is included within housing 14. More specifically, a take-up wheel 30 is housed within housing 14 at a position adjacent a top wall 18. Cord 22 extends through an opening 32 in top wall 18, and then around take-up wheel 30. As will be recognized by those skilled in the art, take-up wheel 30 is spring loaded and includes various stop mechanisms to easily accommodate the withdrawal and retraction of cord 22.

To provide further convenience, top wall 18 also includes a recessed section 40 which is configured to receive control panel 20. In addition, a magnetic coupling system is utilized to hold control panel 20 in place when seated in recessed section 40. In this particular embodiment, a pair of magnets 42 are positioned immediately below recessed portion 40 while cooperating metal plates 44 are positioned in a lower portion of control panel 20. As anticipated, a magnetic coupling is created when control panel 20 is seated in recessed section 40. In this matter, control panel 20 will be securely held in place until selectively removed by the user.

Also illustrated in FIG. 4 are the various components of exercise device 10 which are contained within housing 14. Again, exercise device 10 of the present invention provides dual exercise therapies to the user, in order to increase efficiency and effectiveness. A first therapy is provided by a vibration system 50 located within housing 14. Although the components are not specifically illustrated in FIG. 4, it is contemplated that vibration system 50 will include a motor and an eccentric weight mechanism attached thereto. As will be easily recognized by those skilled in the art, actuation of the motor and rotation of this eccentric weight will cause internal vibration. When the exercise device 10 is attached to a user, this vibration will be transmitted to a user's body, thus creating a desired physiological effect. The size and speed of the eccentric weight can vary depending upon the desired strength and frequency of the vibration.

In addition, exercise device 10 also includes an electrical stimulation system 60 configured to provide low current electrical signals to the user's body. As generally discussed above, exercise device 10 includes electrodes 16 positioned on one side of belt structure 12. These electrodes are driven or powered by electrical signal stimulation system 60 based upon the desired and well understood methodologies. These electrical stimulation methodologies will induce muscle contractions, thus providing desired muscle conditioning. As will be further appreciated, the strength and frequency of the electrical stimulation signals will directly effect the muscle exercise encountered by a user.

The overall operation of exercise device 10 is controlled by a system controller 100 which is also contained within housing 14. System controller 100 communicates with control panel 20, vibration system 50 and electrical stimulation system 60 in an effort to provide coordinated operation of all of these components. System controller 100 may include any well understood microprocessor or microcontroller, or variations thereof. Additionally, control processor 100 may be located within the body of control panel 20, to more easily communicate with display 24 and control buffers 28.

As discussed above, the preferred embodiments of the present invention provide both effective exercise therapies to a user, while also being convenient and easy to use. Naturally, variations are possible which will still achieve the coordinated overall operation as discussed above. For example, the control panel could be physically coupled, using appropriate clips or related physical structures as opposed to the magnetic coupling discussed above. Alternatively, the control panel could be coupled to the various therapy devices via a wireless coupling system. Further, the electrodes could take many forms depending on the therapy desired, or coupld include a number of additional electrodes. Additionally, exercise device 10 could be configured as a smaller belt, thus accommodating attachment to the user's arms or legs, as opposed to around their waist. Many different variations are also contemplated depending upon the desired positioning of the device and the related body structure to which the exercise therapies are being applied. As an additional alterative, those skilled in the art will recognize that alternative methods for generating the desired vibration generation could be used.

Although specific embodiments are discussed above and shown in the drawings, several additional variations exist. It is intended that all variations coming within the general scope and spirit of the following claims are necessarily included in this description.

What is claimed is:

1. A weight loss belt for providing focused muscle conditioning to a targeted area of a user's body, comprising:
an elongated belt structure having cooperating fastening mechanisms at opposite ends thereof to accommodate wrapping around a predetermined portion of the user's body;
a housing carried by the belt on a side of the belt opposite the user when the belt is wrapped around the user's body;
a first exercise therapy system within the housing creating a vibration therapy signal which is passed on to the user when the user wears the belt, the first therapy system including an eccentric weight rotated by a motor, thereby providing vibration to the entire belt structure when the weight is rotated;
a second exercise therapy system having a pair of electrodes positioned on an outer surface of the belt structure opposite the housing, the electrodes positioned to contact the user when the belt is worn, the second therapy system having a control system electrically coupled to the electrodes to generate electrical therapy pulses thereby causing a desired physical reaction in the user;
a user interface member attached to the housing via a control wire, and removably coupled to the housing so as to allow the interface panel to be pulled away from the belt a predetermined distance, the user interface panel having separate controls for operating the first exercise therapy system and the second exercise therapy system either separately or simultaneously.

2. The weight loss belt of claim 1 wherein the belt includes a spring-loaded take-up mechanism coupled to the control wire, the take-up mechanism causing the wire to be retracted within the belt whenever the user interface member is seated on the housing.

3. The weight loss belt of claim 2 wherein the housing and the user interface member include cooperating magnetic structures to cause the user interface member to be magnetically seated at a predetermined location on the housing while also allowing the user interface member to be selectively removed.

4. An exercise therapy device attachable adjacent a selected portion of a user's body, comprising:
a housing for carrying a first therapy device and a second therapy device;
a positioning device attachably positioning the first therapy device and the second therapy device adjacent a predetermined portion of the user's body;
wherein the first therapy device creates a vibration therapy signal which is passed on to the user when the housing and positioning device is attached to the predetermined portion of the user's body, the first therapy device further comprises an eccentric weight rotated by a motor, thereby providing vibration to the entire housing structure when the weight is rotated;
wherein the second therapy device further comprises a pair of electrodes positioned on an outer surface of the housing in a manner to contact the user when the positioned adjacent the predetermined portion of the user's body, the second therapy device having a control system electrically coupled to the electrodes to generate electrical therapy pulses thereby causing a desired physical reaction in the user;
a user interface member operably coupled to the housing so as to allow the interface panel to be pulled away from the belt a predetermined distance, the user interface panel having separate controls for operating the first exercise therapy device and the second exercise therapy device either separately or simultaneously.

5. The exercise therapy device of claim 4 wherein the user interface is operably coupled to the housing via a control wire.

6. The exercise therapy device of claim 5 wherein the housing includes a spring-loaded take-up mechanism coupled to the control wire, the take-up mechanism causing the wire to be retracted within the belt whenever the user interface member is seated on the housing.

7. The exercise therapy device of claim 4 wherein the housing and the user interface member include cooperating magnetic structures to cause the user interface member to be magnetically seated at a predetermined location on the housing while also allowing the user interface member to be selectively removed.

8. The exercise therapy device of claim 4 wherein the user interface member further comprises at least one user interface button for allowing the user to adjust operation of the first exercise therapy device and the second exercise therapy device.

9. The exercise therapy device of claim 8 wherein the user interface member further comprises a user display for displaying at least one operating parameter of at least the first exercise therapy device or the second exercise therapy device.

10. The exercise therapy device of claim 4 wherein the second therapy device further comprises a second set of electrodes for providing additional electrical therapies to a second location of a user's body.

11. The exercise therapy device of claim 4 wherein the first therapy device is capable of providing vibration therapy along a range of vibration frequencies.

12. The exercise therapy device of claim 5 wherein the control panel is operably coupled via a wireless connection.
